(19) United States
(12) Patent Application Publication
(10) Pub. No.: US 2023/0295843 A1
(43) Pub. Date: Sep. 21, 2023

(54) TWISTED YARN, TWISTED YARN PRODUCTION DEVICE AND TWISTED YARN PRODUCTION PROCESS

(71) Applicant: KAIPING PANTHER TEXTILES CO., Ltd., Kaiping (CN)

(72) Inventor: Di Tian KUANG, Kaiping, Guang Dong Province (CN)

(21) Appl. No.: 17/941,690

(22) Filed: Sep. 9, 2022

(30) Foreign Application Priority Data
Mar. 15, 2022 (CN) 202210250314.1

(51) Int. Cl. D02G 1/02; D02G 1/16

(52) U.S. Cl. CPC D02G 1/028; D02G 1/165; D10B 2331/12

(57) ABSTRACT

The invention discloses a twisted yarn, a twisted yarn production device and a twisted yarn production process. The twisted yarn is obtained from an air-covered yarn and a core-spun spandex yarn through doubling, twisting and winding. Compared with the prior art, the invention utilizes the feature that the air-covered yarn has rhythmic network points. After the air-covered yarn and the core-spun spandex yarn are made into a twisted yarn, the air-covered yarn can clamp the core-spun spandex yarn, thereby effectively preventing the retraction of the spandex in the core-spun spandex yarn.

### TECHNICAL FIELD

The present invention relates to the technical field of double core spandex yarns, particularly to a twisted yarn, a twisted yarn production device and a twisted yarn production process.

### BACKGROUND ART

The core spun yarn is generally prepared from a synthetic fiber filament with desirable strength and elasticity as the core, and covered with cotton, wool, viscose fiber and other staple fibers through twisting and spinning and has the advantages of both the core filament yarn and the outer staple fibers. The popular core-spun yarns are polyester/cotton core-spun yarns and core-spun spandex yarns. The core-spun spandex yarn is a yarn prepared from a spandex filament as a core yarn, covered with other fibers. The knitted fabric or denim material made of such core-spun yarns stretches freely and fits comfortably when worn. When there are multiple core filaments and one of them is spandex, the yarn is called a double core spandex yarn.

In the existing double core spandex yarn, the outer fibers wrap the inner yarn core in a spiral form, and the yarn with a sheath-core structure is woven to obtain a high-elasticity denim fabric. Due to the high elasticity of the fabric, if the fabric is left for a long time after being cut, the spandex yarn will retract. During the sewing process, the spandex yarn is not pressed down, resulting in the phenomenon of loss of elasticity and puckering at the seam position after washing. In addition, the splicing of ring-spun core-spun yarns is also difficult. After the spun yarn is broken, the twist of the yarn end wound on the bobbin is less and loose, which makes the core spandex yarn retract in the length direction, resulting in a “hollow core” of the double-core spandex yarn during splicing. Due to “hollow core”, “bare core tail” and other problems of splicing the denim fabric eventually loses its elasticity.

### SUMMARY OF THE INVENTION

The present invention aims to provide a twisted yarn, a twisted yarn production device and a twisted yarn production process to avoid partial loss of elasticity of the denim fabric due to the retraction of spandex.

In order to achieve the above purpose, the present invention provides the following technical solution:

The present invention discloses a twisted yarn, which is obtained from an air-covered yarn and a core-spun spandex yarn through doubling, twisting and winding.

Preferably, the air-covered yarn is prepared from spandex and filament.

Preferably, the core-spun spandex yarn is prepared from spandex and staple fibers.

The present invention further discloses a twisted yarn production device, comprising an air-covered yarn supply device, a core-spun spandex yarn supply device and a twisting device. The air-covered yarn supply device is used for providing an air-covered yarn, the core-spun spandex yarn supply device is used for providing a core-spun spandex yarn, and the twisting device is used for doubling, twisting and winding the air-covered yarn and the core-spun spandex yarn to obtain a twisted yarn.

Preferably, the air-covered yarn supply device is an air-covered yarn production device, and the core-spun spandex yarn supply device is a core-spun spandex yarn unwinding device; the air-covered yarn production device is used for preparing the air-covered yarn, and the core-spun spandex yarn unwinding device is used for unwinding the core-spun spandex yarn.

The present invention further provides a twisted yarn production process, in which an air-covered yarn and a core-spun spandex yarn are doubled, twisted and wound to obtain a twisted yarn.

Preferably, the core-spun spandex yarn is directly unwound from a core-spun spandex unwinding device.

Preferably, the air-covered yarn is prepared from spandex and filament on site.

Compared with the prior art, the present invention has the following technical effects:

The present invention utilizes the feature that the air-covered yarn has rhythmic network points. After the air-covered yarn and the core-spun spandex yarn are made into a twisted yarn, the air-covered yarn can clamp the core-spun spandex yarn, thereby effectively preventing the retraction of the spandex in the core-spun spandex yarn.

### BRIEF DESCRIPTION OF THE DRAWINGS

In order to more clearly illustrate the technical solutions in the embodiments of the present invention or the prior art, the drawings required in the embodiments will be briefly described below, and obviously, the drawings in the description below are merely some embodiments of the present invention. Those of ordinary skill in the art can also obtain other drawings without creative work based on the provided drawings.

FIG. 1 is a schematic view of an air-covered yarn;

FIG. 2 is a schematic view of a core-spun spandex yarn;

FIG. 3 is a schematic view of a twisted yarn in this embodiment;

FIG. 4 is a schematic view of a twisted yarn production device in this embodiment;

Description of reference signs: 1-air-covered yarn; 2-core-spun spandex yarn; 3-twisted yarn; 4-spandex; 5-staple fiber; 6-filament.

### DETAILED DESCRIPTION

The technical solutions in the embodiments of the present invention will be clearly and completely described below in conjunction with the drawings in the embodiments of the present invention. Obviously, the described embodiments are only some, not all of the embodiments of the present invention. All other embodiments obtained by those of ordinary skill in the art without creative work based on the embodiments of the present invention are within the scope of protection of the present invention.

The present invention aims to provide a twisted yarn, a twisted yarn production device and a twisted yarn production process to avoid partial loss of elasticity of the denim fabric due to the retraction of spandex.

In order to make the above object, features and advantages of the present invention more obvious and understandable, the present invention will be further elaborated by referring to the accompanying drawings and specific embodiments.

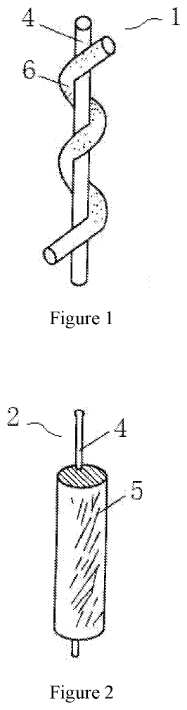

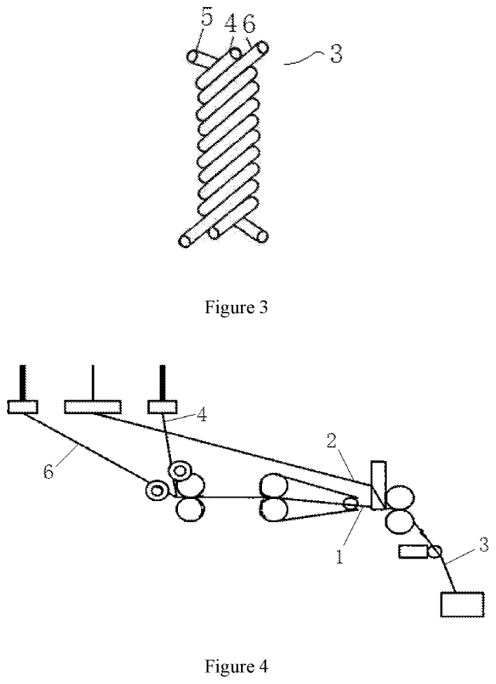

As shown in FIG. 1 to FIG. 3, this embodiment provides a twisted yarn 3, which is obtained from an air-covered yarn 1 and a core-spun spandex yarn 2 through doubling, twisting and winding. Since the air-covered yarn 1 is a yarn with rhythmic network points formed by simultaneously drafting a filament 6 and a spandex 4 through a nozzle of a certain model and regularly spraying high-pressure compressed air, the air-covered yarn 1 can effectively prevent retraction of the spandex 4 in the core-spun spandex yarn 2. In this embodiment, the air-covered yarn 1 is prepared from the spandex 4 and the filament 6, and the core-spun spandex yarn 2 is prepared from the spandex 4 and staple fibers 5.

As shown in FIG. 4, this embodiment further provides a twisted yarn production device, comprising an air-covered yarn supply device, a core-spun spandex yarn supply device and a twisting device. The air-covered yarn supply device is used for providing an air-covered yarn 1, the core-spun spandex yarn supply device is used for providing a core-spun spandex yarn 2, and the twisting device is used for doubling, twisting and winding the air-covered yarn 1 and the core-spun spandex yarn 2 to obtain a twisted yarn 3. As the air-covered yarn 1 contains rhythmic network points, it can effectively prevent retraction of the spandex 4 in the core-spun spandex yarn 2.

The air-covered yarn supply device can be a production device of the air-covered yarn 1, or an unwinding device of the air-covered yarn 1. Likewise, the core-spun spandex yarn supply device can be a production device of the core-spun spandex yarn 2, or an unwinding device of the core-spun spandex yarn 2.

In this embodiment, the air-covered yarn supply device is a production device of the air-covered yarn 1, and the core-spun spandex yarn supply device is an unwinding device of the core-spun spandex yarn 2. The air-covered yarn production device is used for preparing the air-covered yarn 1, and the core-spun spandex yarn unwinding device is used for unwinding the core-spun spandex yarn 2.

The present invention further provides a twisted yarn production process, in which an air-covered yarn 1 and a core-spun spandex yarn 2 are doubled, twisted and wound to obtain a twisted yarn 3.

Preferably, the core-spun spandex yarn 2 is directly unwound from a core-spun spandex 2 unwinding device.

Preferably, the air-covered yarn 1 is prepared from a spandex 4 and a filament 6 on site.

Specific examples are used herein to illustrate the principle and embodiments of the present invention. The description of the above embodiments is used to help understand the method and core idea of the present invention. Meanwhile, for those of ordinary skill in the art, changes may be made to the embodiments and scope of application of the present invention according to the spirit of the present invention. To sum up, the content of the present invention should not be understood as a limitation to the present invention.

1. A twisted yarn, wherein the twisted yarn is obtained from an air-covered yarn and a core-spun spandex yarn through doubling, twisting and winding.

2. The twisted yarn according to claim 1, wherein the air-covered yarn is prepared from spandex and filament.

3. The twisted yarn according to claim 1, wherein the core-spun spandex yarn is prepared from spandex and staple fibers.

4. A twisted yarn production device, wherein the device comprises an air-covered yarn supply device, a core-spun spandex yarn supply device and a twisting device; the air-covered yarn supply device is used for providing an air-covered yarn, the core-spun spandex yarn supply device is used for providing a core-spun spandex yarn, and the twisting device is used for doubling, twisting and winding the air-covered yarn and the core-spun spandex yarn to obtain a twisted yarn.

5. The twisted yarn production device according to claim 4, wherein the air-covered yarn supply device is an air-covered yarn production device, and the core-spun spandex yarn supply device is a core-spun spandex yarn unwinding device; the air-covered yarn production device is used for preparing the air-covered yarn, and the core-spun spandex yarn unwinding device is used for unwinding the core-spun spandex yarn.

6. A twisted yarn production process, wherein an air-covered yarn and a core-spun spandex yarn are doubled, twisted and wound to obtain a twisted yarn.

7. The twisted yarn production process according to claim 6, wherein the core-spun spandex yarn is directly unwound from a core-spun spandex unwinding device.

8. The twisted yarn production process according to claim 6, wherein the air-covered yarn is prepared from spandex and filament on site.
